(19) United States
(12) Patent Application Publication
(10) Pub. No.: US 2004/0111632 A1
(43) Pub. Date: Jun. 10, 2004

(54) System and method of virus containment in computer networks

(76) Inventor: Avner Halperin, Tel-Aviv (IL)

Correspondence Address: DANIEL J SWIRSKY, PO BOX 2345, BEIT SHEMESH, 99544, IL

(21) Appl. No.: 10/429,248

(22) Filed: May 5, 2003

Related U.S. Application Data
(60) Provisional application No. 60/377,618, filed on May 6, 2002.

(51) Int. Cl. G06F 11/30; G06F 15/173

(52) U.S. Cl. 713/200; 713/187; 709/224

(57) ABSTRACT

A method for detecting malicious activity in a computer network including deploying one or more suspicious event sensors, each sensor operative to detect a predefined suspicious event on at least one computer, logging any suspicious events detected by the sensors during normal operation of the network when no malicious activity is present, calculating a statistical distribution of the logged events, comparing the results of the event sensors to the statistical distribution and determining the probability of the result against a predefined threshold, and activating any of an alarm and a defense mechanism where the probability exceeds the predefined threshold.

### CROSS-REFERENCE TO RELATED APPLICATIONS

This application claims the benefit of U.S. Provisional Patent Application Ser. No. 60/377,618, filed May 6, 2002, entitled “System and Method of Virus Containment in Computer Networks,” and incorporated herein by reference in its entirety.

### FIELD OF THE INVENTION

The present invention relates to computer and computer network security in general, and more particularly to detection and prevention of malicious computer programs.

### BACKGROUND OF THE INVENTION

A “computer virus” is a computer program that is designed to infiltrate computer files and other sensitive areas on a computer, often with the purpose of compromising the computer's security, such as by erasing or damaging data that is stored on the computer or by obtaining and forwarding sensitive information without the computer user's permission, or with the purpose of spreading to as many computers as possible. In most cases, viruses are spread when computer users send infected files to other computer users via electronic mail (e-mail), via data storage media such as a diskette or a compact disc, or by copying infected files from one computer to another via a computer network.

Some viruses are capable of spreading from computer to computer with little or no intervention on the part of the computer user. These viruses are designed to copy themselves from one computer to another over a network, such as via e-mail messages. A virus that spreads via e-mail messages will typically access an e-mail program's address book or sent/received mail folders and automatically send itself to one or more of these addresses. Alternatively, the virus may attach itself to otherwise innocuous e-mail messages that are sent by a computer user to unsuspecting recipients. Other viruses appear on web pages and are spread by being downloaded into a user's computer automatically when the infected web page is viewed.

The standard approach to protecting against computer viruses is to detect their presence on a computer or network using a virus scanner. However, while virus scanners can effectively detect known computer viruses, they generally cannot reliably detect unknown computer viruses. This is because most virus scanners operate by searching a computer for tell-tale byte sequences known as “signatures” that exist in known viruses. Thus, by definition, new viruses whose byte sequences are not yet known to virus scanners cannot be detected in this manner.

Another approach involves using antivirus software that employs heuristic techniques to identify typical virus behavior by characterizing legitimate software behavior and then identifying any deviation from such behavior. Unfortunately, computer user behavior is quite dynamic and tends to vary over time and between different users. The application of heuristic techniques thus often results in a false alarm whenever a user does anything unusual, leading computer users to disable such software or set the sensitivity of such software so low to the point where new viruses are often not identified.

### SUMMARY OF THE INVENTION

The present invention seeks to provide for the detection and containment of malicious computer programs that overcomes disadvantages of the prior art.

The disclosures of all patents, patent applications, and other publications mentioned in this specification and of the patents, patent applications, and other publications cited therein are hereby incorporated by reference in their entirety.

### BRIEF DESCRIPTION OF THE DRAWINGS

The present invention will be understood and appreciated more fully from the following detailed description taken in conjunction with the appended drawings in which:

FIG. 1 is a simplified conceptual illustration of a computer virus detection and containment system, useful in understanding the present invention;

FIG. 2 is a simplified flowchart illustration of an exemplary method of operation of the system of FIG. 1, useful in understanding the present invention;

FIG. 3 is a simplified flowchart illustration of an exemplary method of operation of the system of FIG. 1, useful in understanding the present invention;

FIG. 4 is a simplified flowchart illustration of an exemplary method of operation of the system of FIG. 1, useful in understanding the present invention;

FIG. 5 is a simplified conceptual illustration of a computer virus detection and containment system, useful in understanding the present invention;

FIG. 6 is a simplified flowchart illustration of an exemplary method of operation of the system of FIG. 5, useful in understanding the present invention;

FIG. 7 is a simplified flowchart illustration of an exemplary method of computer virus detection and containment, useful in understanding the present invention;

FIG. 8 is a simplified conceptual illustration of a malicious software detection system, useful in understanding the present invention;

FIG. 9 is a simplified flowchart illustration of an exemplary method of operation of the system of FIG. 8, useful in understanding the present invention;

FIGS. 10A and 10B are simplified conceptual illustrations of group aggregation, useful in understanding the present invention; and

FIG. 11 is a simplified flowchart illustration of an exemplary method of operation of the system of FIG. 8, useful in understanding the present invention.

### DETAILED DESCRIPTION OF PREFERRED EMBODIMENTS

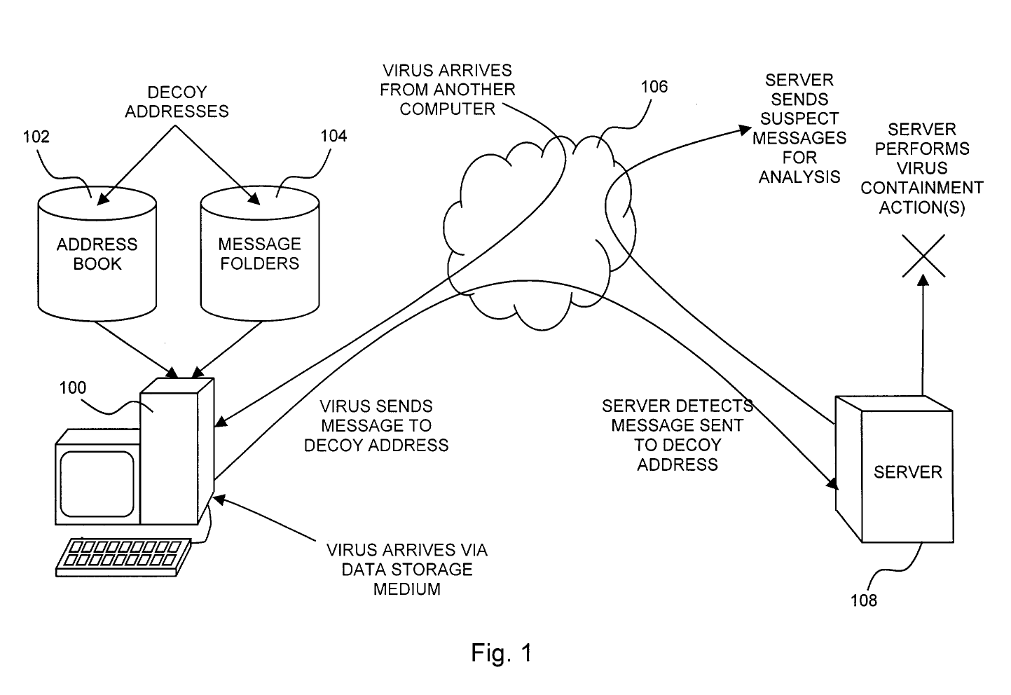

Reference is now made to FIG. 1, which is a simplified conceptual illustration of a computer virus detection and containment system, useful in understanding the present invention. In the system of FIG. 1 a computer 100 is shown, typically configured with client software enabling computer 100 to be used for sending and receiving messages, such as e-mail messages. The client software typically includes one or more address books 102 as well as one or more folders 104, such as “inbox” and “sent” folders for storing received and sent messages. Computer 100 is also configured to communicate via a network 106, such as the Internet. Messages sent by computer 100 via network 106 are typically first received by a server 108 which then forwards the messages to their intended recipients, preferably after a predefined delay period.

In accordance with the present invention one or more decoy addresses are inserted into either or both address book 102 and folders 104. In folders 104 the decoy addresses may be included within stored messages. Decoy addresses may also be included within other files stored on computer 100, such as HTML files. Decoy addresses may be valid addresses, such as addresses that terminate at server 108, or invalid addresses, and are preferably not addresses that are otherwise found in address book 102 and folders 104 and that might be purposely used by a user at computer 100. The decoy addresses are preferably known in advance to server 108. Preferably, the decoy addresses are not addresses that terminate at servers outside of a predefined group of servers, such as that which may be defined for a company or other organization. Alternatively, the decoy addresses may be terminated at a server located at a managed security service provider which provides virus detection and containment services for the network of computer 100.

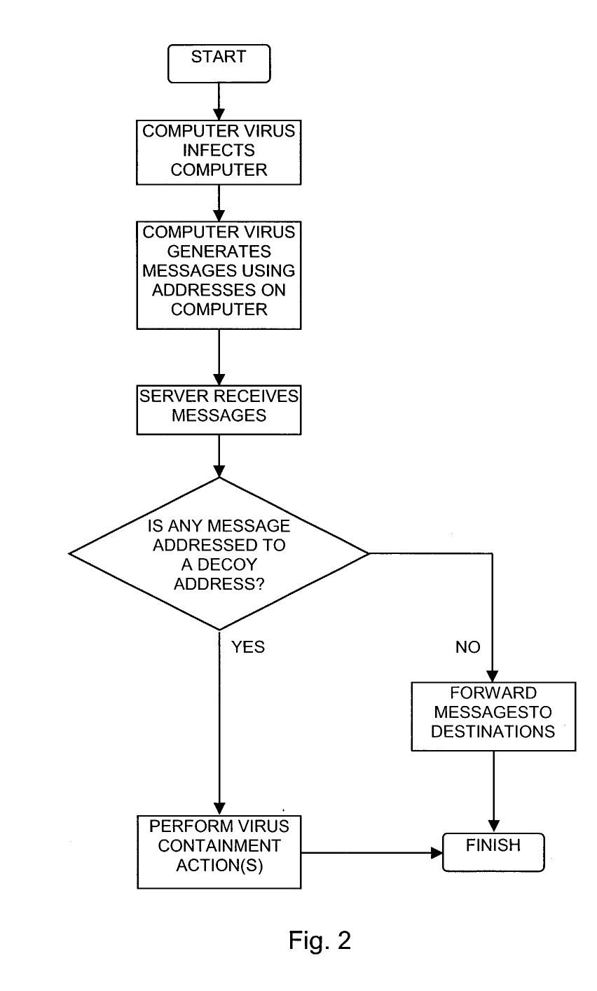

Reference is now made to FIG. 2, which is a simplified flowchart illustration of an exemplary method of operation of the system of FIG. 1, useful in understanding the present invention. In the method of FIG. 2, computer 100 becomes infected by a computer virus, such as by receiving the virus from another computer via a network 102 or via the introduction of infected data storage media such as a diskette or a compact disc into computer 100. As the virus attempts to propagate it selects one or more valid and decoy addresses from address book 102 and folders 104, automatically generates messages that incorporate the virus, typically as an attachment, and forwards the messages to server 108. Server 108 scans messages received from computer 100. Should server 108 detect a message addressed to a decoy address, server 108 may initiate one or more virus containment actions such as, but not limited to:

Suspending any or all messages sent by computer 100, thereby preventing messages sent by computer 100 from being forwarded to recipients.

Forwarding messages that are addressed to a decoy address to a third party for analysis, such as a company or other body that produces anti-virus software.

Notifying a user at computer 100 of the suspicious message activity.

Notifying a system administrator that a virus may have been detected.

Stopping all messages from being forwarded by server 108 to their intended destinations. Taking away all privileges that computer 100 has to access network 102 and/or rights to access shared network files or directories.

Changing the delay period of all messages received by server 108, thus putting the entire network on “virus alert.”;

Sending a command to network devices connected to network 102, such as switches or routers, to block all attempts by computer 100 to access network 102. This may be done, for example, by using SNMP commands.

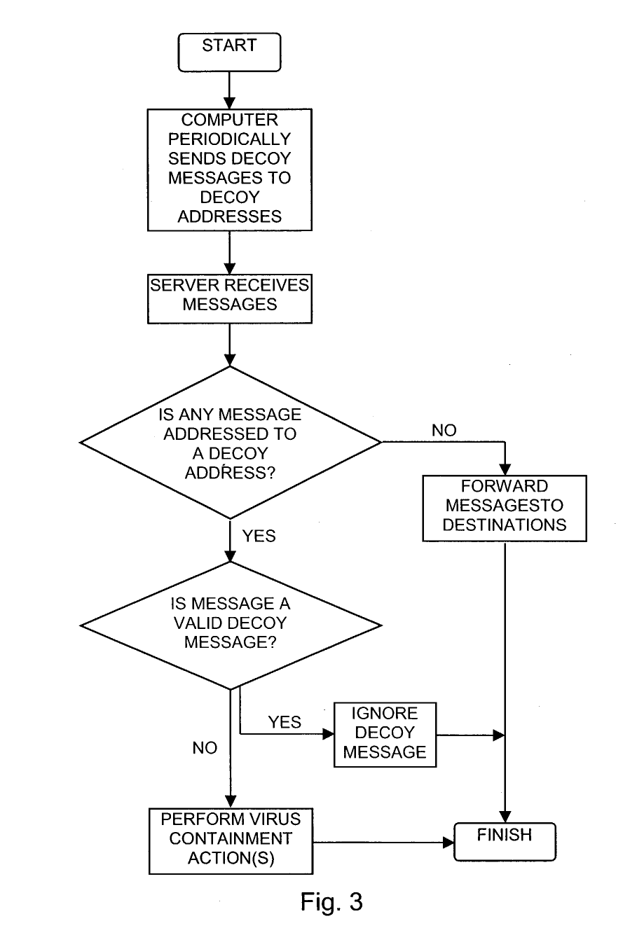

Reference is now made to FIG. 3, which is a simplified flowchart illustration of an exemplary method of operation of the system of FIG. 1, useful in understanding the present invention. In the method of FIG. 3 computer 100 is configured to periodically send decoy messages to one or more of the decoy addresses, with or without attachments, and in a manner that would enable server 108 to determine that the messages are valid decoy messages and not messages sent by a virus. For example, computer 100 may send decoy messages according to a schedule that is known in advance to server 108, or may include text and/or attachments whose characteristics are known in advance to server 108. Should computer 100 become infected by a computer virus that generates its own messages, as the virus attempts to propagate it selects one or more valid and decoy addresses from address book 102 and folders 104, automatically generates messages that incorporate the virus, typically as an attachment, and forwards the messages to server 108. Alternatively, should computer 100 become infected by a computer virus that attaches itself to outgoing messages that it does not automatically generate, the virus will attach itself to a periodic decoy message.

The method of FIG. 3 continues with server 108 scanning messages received from computer 100. Should server 108 detect a message addressed to a decoy address, server 108 determines whether the message is a valid decoy message or otherwise. If the message is not a valid a decoy message, and, therefore, possibly a message sent by a virus, server 108 may initiate one or more virus containment actions such as is described hereinabove with reference to FIG. 2.

In order to “bait” computer viruses that selectively choose for propagation addresses from address book 102 and folders 104 based on usage, such as by selecting addresses to which computer 100 most recently sent message or to which computer 100 most frequently sends messages, computer 100 preferably sends decoy messages to different decoy addresses at various frequencies in order not to distinguish the pattern of decoy messages from computer 100's normal message-sending patterns.

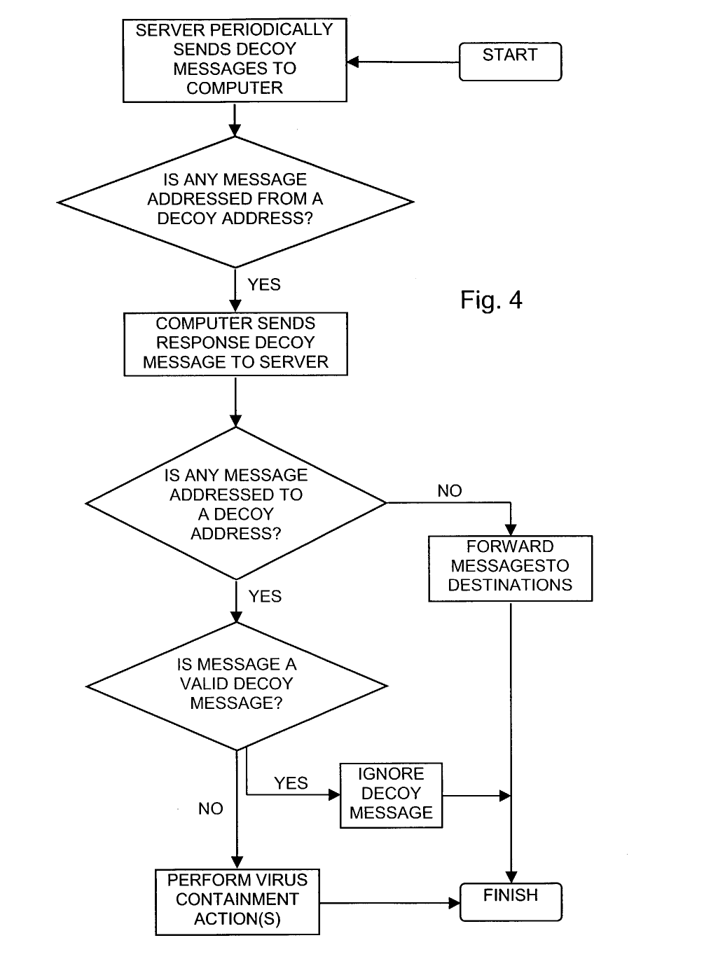

Reference is now made to FIG. 4, which is a simplified flowchart illustration of an exemplary method of operation of the system of FIG. 1, useful in understanding the present invention. In the method of FIG. 4 server 108 is configured to periodically send decoy messages to computer 100, with or without attachments. Each decoy message preferably indicates that it was sent from a decoy address known in advance to computer 100. Upon detecting the decoy message, computer 100 replies to the decoy message by sending a decoy message of its own to the decoy address indicated in server 108's decoy message, either immediately or according to a schedule that is known in advance to server 108. The decoy message sent by computer 100 may be the same decoy message sent by server 108, or may be a different decoy message including text and/or attachments whose characteristics are known in advance to server 108. Where computer 100 sends the decoy message received from server 108 back to server 108, computer 100 may be configured to open the decoy message and/or its attachment prior to sending in order to “bait” viruses that look for such activity.

The method of FIG. 4 continues with server 108 scanning messages received from computer 100. Should server 108 detect a message addressed to a decoy address, server 108 determines whether the message is a valid decoy message or otherwise. If the message is not a valid a decoy message, and, therefore, possibly a message sent by a virus or a message changed by a virus, server 108 may initiate one or more virus containment actions such as is described hereinabove with reference to FIG. 2.

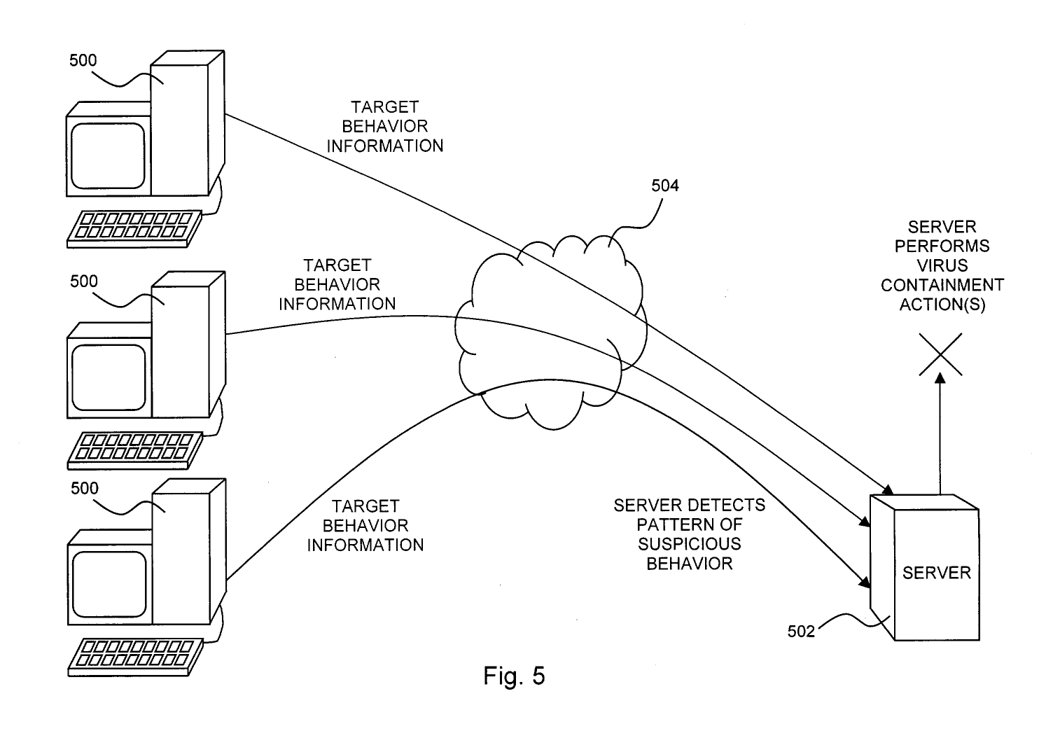

Reference is now made to FIG. 5, which is a simplified conceptual illustration of a computer virus detection system, useful in understanding the present invention. In the system of FIG. 5 one or more computers 500 are shown, being configured to communicate with a server 502 via a network 504, such as the Internet.

As was noted hereinabove, computer viruses typically infect a computer system by moving from one computer to another within a computer network, such as via messages and through the copying or sharing of files. One characteristic of such types of infection is that computers that share the same network services are often infected within the same time period. A computer virus can thus be detected by correlating behavior and/or data from different computers. Activity that cannot be confidently attributed to a virus when observed on one computer can be clearly identified as such when observed on several computers in a network.

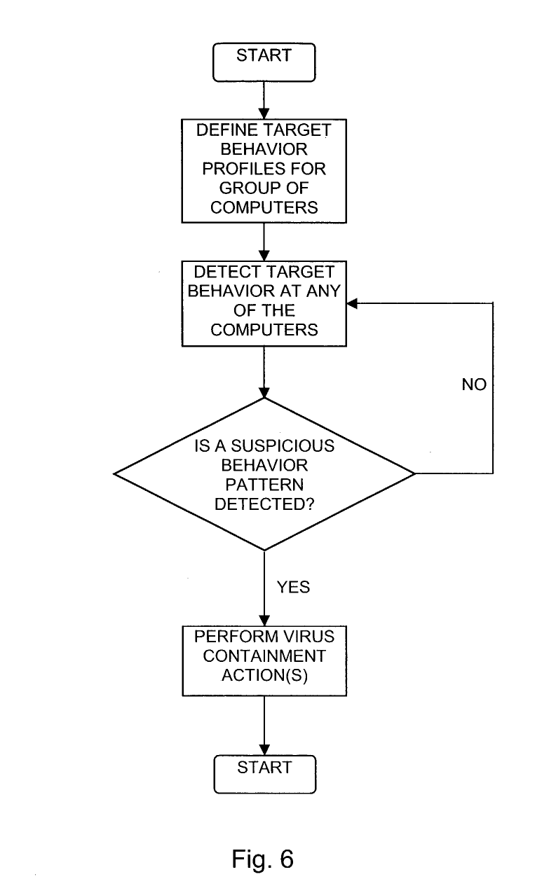

Reference is now made to FIG. 6, which is a simplified flowchart illustration of an exemplary method of operation of the system of FIG. 5, useful in understanding the present invention. In the method of FIG. 6 one or more target behavior profiles are defined for computers 500. Each target behavior profile describes behavior that should be the subject of correlation analysis as described in greater detail hereinbelow. Target behavior may be any and all computer activity. Some examples of target behavior profiles include:

Sending messages to more than a predefined number of users during a predefined period of time;

Sending messages not as a result of a direct user interaction with the Graphic User Interface (GUI) of the message software, but rather as the result of a directive from a software application;

Modifying operating system files such as the Microsoft Windows® registry;

Deleting more than a predefined number of files on the computer's hard disk during a predefined period of time;

Loading a new software application into the computer's RAM;

Sending a file attached to a message several times from the same user;

Sending a file attachment of a specific type (e.g., .exe, .doc, .zip);

Attempting to contact previously unused or unknown IP addresses or IP Sockets.

Computers 500 may be configured with such target behavior profiles and the ability to detect associated target behavior and notify server 502 accordingly. Additionally or alternatively, server 502 may be configured with such target behavior profiles and may detect associated target behavior at computers 500 using conventional techniques. After collecting information regarding target behavior detected at two or more of computers 500, server 502 may then correlate the presence of target behavior detected at two or more of computers 500 in order to determine whether the correlated target behavior corresponds to a predefined suspicious behavior pattern of target behavior as an indication that a computer virus may have infected those computers. Any known behavior correlation techniques may be used, such as identifying the same activity in different computers at about the same time, or by identifying repeating patterns of data within the memories of two or more computers. Examples of expressions of such suspicious behavior patterns include:

A certain percentage of the computers in the network sending more than 10 messages per minute in the last 5 minutes;

A certain percentage of the computers in the network sending messages not initiated via the message GUI in the last 1 minute;

A certain percentage of the computers in the network deleting more than 10 files in the last 1 minute;

A certain percentage of computers in the network deleting a file by the same name within the last 1 hour.

A certain percentage of the computers in the network deleting a file with the same name in the last 1 minute;

A certain percentage of the computers in the network to which changes to the Microsoft Windows® Registry occurred in the last 1 minute;

A certain percentage of the computers in the network sending the same file attachment via a message in the last 15 minutes;

A certain percentage of the computers in the network sending file attachments via one or more messages in the last hour where each of the files includes the same string of bits;

A certain percentage of the computers in the network having an unusual level of correlation of data between files sent as attachments. For example, since viruses known as “polymorphic viruses” may change their name as they move from one computer to another, one way to identify such viruses is to identify attachments that have the same or similar data, whether or not they have the same name.

Upon detecting a suspicious behavior pattern server 502 may initiate one or more virus containment actions such as is described hereinabove with reference to FIG. 2.

In the systems and methods described hereinabove with reference to FIGS. 1, 2, 3, 4, 5, and 6, the server may include a buffer or other mechanism whereby messages received from the computer are held, typically for a predefined delay period, prior to forwarding the messages to their intended recipients. In this way, should a computer virus send one or more infected messages to valid, non-decoy addresses before sending an infected message to a decoy address, the infected messages to valid, non-decoy addresses that are still held at the server may be “quarantined” at the server and thus prevented, together with the infected message to a decoy address, from reaching their intended destinations. The server may also notify a system administrator of the quarantined messages who may then check the quarantined to determine whether or not the messages were indeed sent by a computer virus and either allow them to be forwarded to their intended recipients as is, should they not be infected, or only after they have been disinfected. The delay period may be set according to different desired levels of system alertness. The delay period may be applied selectively only to certain types of messages, such as those that have attachments or specific types of attachments (e.g., only .exe, .doc, .xls and .zip file types). This, too, may be applied selectively according to different desired levels of system alertness. The delay period may also vary for different users, different activities (e.g., such as sending or receiving messages), and/or for messages whose destination is outside of a company or other organization versus internal messages.

In an alternative implementation of the buffer described above that is designed to reduce false alarms, should the server receive an invalid decoy message, or should suspicious behavior be detected for multiple computers, the buffer delay period may be increased by a predetermined amount of time, and users may be notified. During the increased delay period, should additional suspicious messages be received, or should other suspicious behavior be detected, if the user and/or system administrator who is authorized to do so has not indicated that the activity is not virus related, only then does the server perform one or more virus containment actions. If, however, during the increased delay period no other suspicious activity is detected, or if the user and/or system administrator who is authorized to do so has indicated that the activity is not virus related, the delay period may be reduced to its previous level and no virus containment action is performed.

It is appreciated that in any of the embodiments described hereinabove computer 100/500 may be configured to act as server 108/502 as well, with computer 100/500 sending decoy and other messages to itself for processing as described hereinabove.

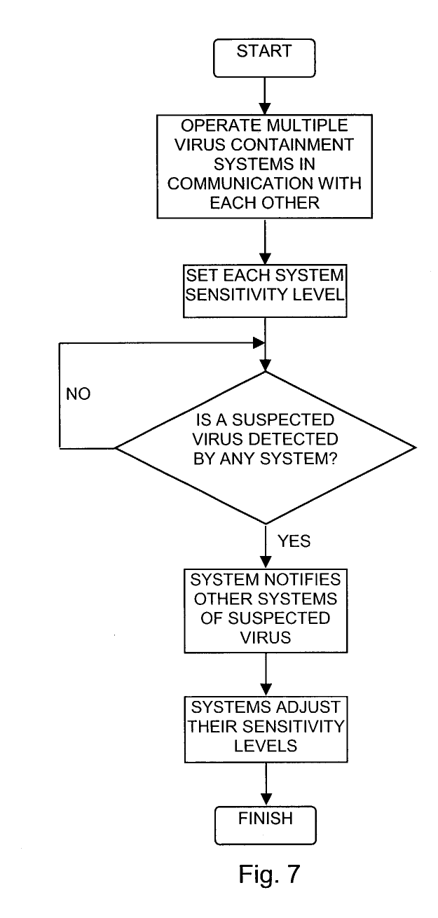

Reference is now made to FIG. 7, which is a simplified flowchart illustration of an exemplary method of virus detection and containment, useful in understanding the present invention. In the method of FIG. 7 a number of virus detection and containment systems are implemented, each system being configured as described hereinabove with reference to FIGS. 1, 2, 3, 4, 5, and 6, and their various servers being in communication with each other. Each system may have the same sensitivity level as expressed by sensitivity parameters such as length of message buffer delay period, which and how many virus containment actions are performed when a suspected virus is detected, which target behavior is tracked, and/or which correlations of target behavior are performed and what are the thresholds for identifying suspicious behavior patterns. Alternatively, different systems may have greater or lesser sensitivity levels, or simply different sensitivity levels by employing different sensitivity parameters. Alternatively, each system may use different system decoys and/or monitor different correlation parameters. It is believed that such diversification between different virus containment systems will improve the chances that at least some of the systems will identify a previously unknown virus. Once one system detects a suspected virus it may notify other systems of the suspected virus. Each system may then increase or otherwise adjust its sensitivity level, preferably according to a predefined adjustment plan and preferably in predefined relation to said notification. For example, if one system detects a suspected virus using a specific decoy or correlation parameter, other systems may heighten their sensitivity level related to that decoy or correlation parameter. It is appreciated that the identification of virus activity may include automatic identification of suspicious activity by a server or a combination of automatic identification and a notification of a system operator and approval by that operator that the suspicious activity is truly a virus, before notifying other servers.

The implementation of the systems and methods described above in large corporate networks and cellular telephone networks that may include hundreds of thousands and possibly millions of computing devices may be optimized by dividing the network into groups of computing devices, such as in accordance with methods described hereinbelow.

For malicious software to be transferred between computers, the computers must have some form of contact with each other. This contact may occur through e-mail communication, SMS messages, or transfer of messages via local communication (e.g., infrared messages or Bluetooth messages). The more frequent the contact, the greater the probability of malicious software being transferred from one computer to another. It has been observed that malicious software will tend to propagate faster within groups of computing devices that tend to communicate frequently with each other. For example, malicious software that is transmitted via infrared transmission between cellular telephones will tend to propagate faster among cellular telephone users that are in the same geographic location than among cellular telephone users that are in different geographic locations. Similarly, malicious software that is transmitted via e-mail will tend to propagate faster among computer users who communicate with each other frequently, such as users within a company or a work group, than among users who are not part of such groups and therefore communicate less frequently. In the context of the present invention a “group” may be defined as two or more computing devices that communicate rather often with each other and are therefore likely to propagate malicious software to each other. For example, in a large corporate network, work teams are natural groups. Communication within the work teams is likely to be more frequent than outside the teams. Malicious software is more likely to propagate more quickly between computing devices belonging to those teams than between computing devices belonging to people who do not communicate with each other frequently or at all. Likewise, communication between work teams belonging to the same department are likely to be more frequent than communication between unrelated work teams. Thus, the corporate hierarchical structural can serve as a natural basis for forming groups and/or a hierarchy of groups where malicious software is likely to propagate quickly.

Another way to divide the network of computing devices into groups is as follows. A measure of logical proximity may be defined between computing devices that is dependent on the frequency of communication between the computing devices or on another measure that is relevant to the probability of virus propagation between computing devices. Using the measure of logical proximity, well known clustering algorithms may be employed to define groups of devices that are “close” to each other in terms of the distance measurement. Clustering algorithms and their uses are described by Jiawei Han and Micheline Kamber in Data Mining: Concepts and Techniques, San Francisco, Calif., Morgan Kaufmann, 2001, and by R. O. Ruda and P. E. Hart in Pattern Classification and Scene Analysis, New York, Wiley & Sons, 1973, both incorporated herein by reference.

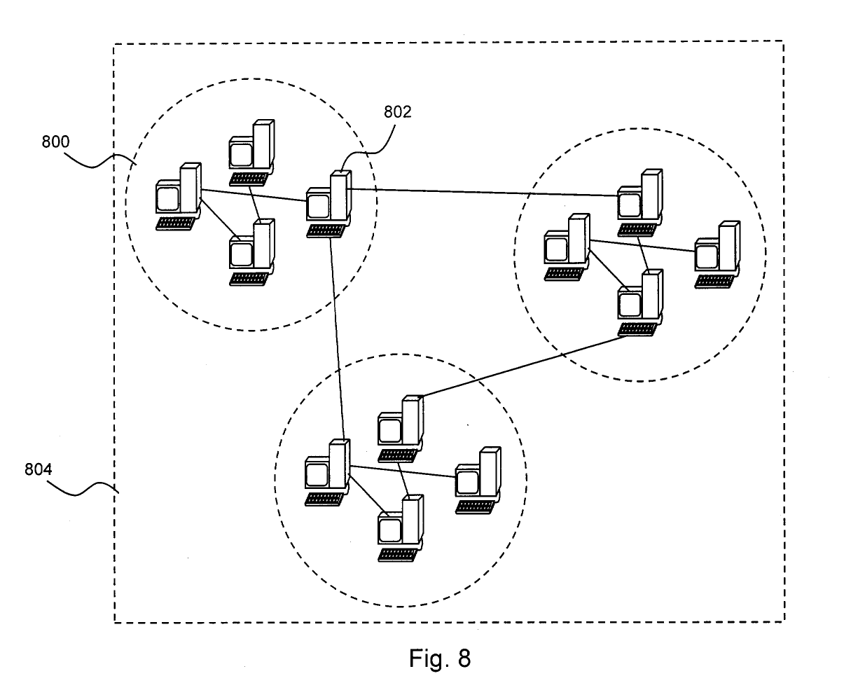

Reference is now made to FIG. 8, which is a simplified conceptual illustration of a malicious software detection system, useful in understanding the present invention. In the system of FIG. 8 one or more groups 800 are shown of computing devices 802, such as computers and computing-capable cellular telephones, that are susceptible to attacks by malicious software, such as computer viruses, Trojan Horses, Denial of Service attack software, etc. Devices 802 are preferably grouped together by some measure of proximity or commonality as described in greater detail hereinbelow, with a particular computing device 802 belonging to one or more groups 800. One or more groups 800 may in turn belong to a group of groups 804. The methods of FIGS. 2, 3, 4, 6 and 7 may then be applied to groups 800 to identify target behavior within groups 800 and/or between them.

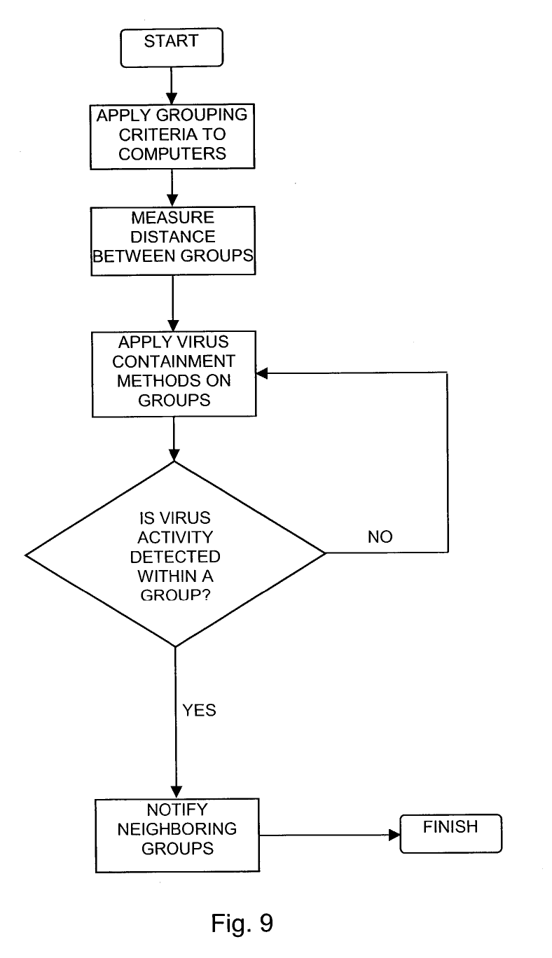

Reference is now made to FIG. 9, which is a simplified flowchart illustration of an exemplary method of operation of the system of FIG. 8, useful in understanding the present invention. In the method of FIG. 9 one or more group proximity measures are applied to multiple computing devices 802. The group proximity measures may, for example, be an average time between e-mail correspondences between any two computing devices 802 during some historical time interval. Computing devices 802 that have an average time between e-mail correspondences that is below a predefined threshold may then be grouped together, or different clustering algorithms may be employed using the group proximity measure. The methods of FIGS. 2, 3, and 4 may then be applied within each group 800. Other examples of group proximity measures include: frequency of voice communication, frequency of SMS communication, or physical proximity. The frequency of communication measures may be calculated using historical log information which is often available to network managers. For example, using the billing database, a cellular service provider may be able to calculate the average frequency of voice communications between any two cellular telephones, thus providing an effective group proximity measure that may be indicative also of the frequency of data communication between such devices.

An alternative group proximity measure may be the frequency with which any two computing devices access shared files. This may be relevant to malicious code that is spread through shared file access.

An alternative method of grouping may employ non-historical information such as customer requests to have discounted communications within frequently communicating groups (e.g., family billing plans for cellular telephones). Alternatively, groups 800 may be formed using current status information such as the physical location of each computing device 802 which allows the calculation of the physical distance between the devices.

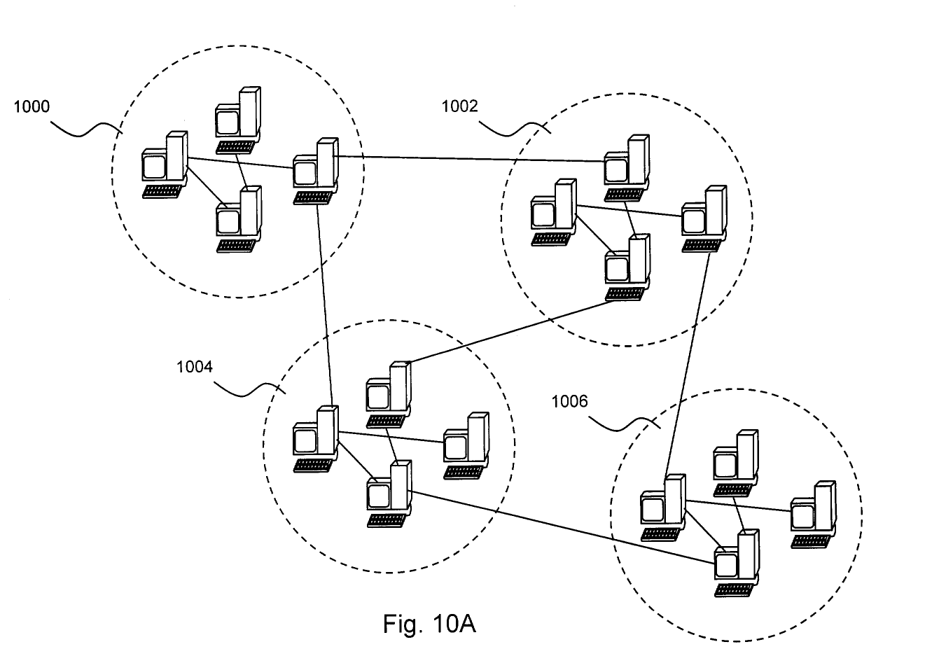

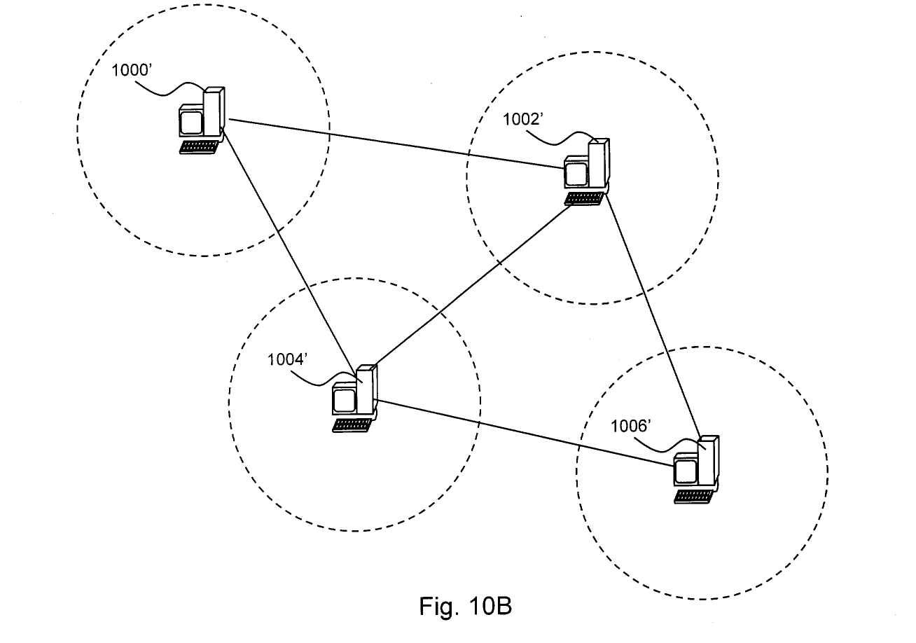

Once groups 800 are defined, a group proximity measure between groups may be calculated using the same or different group proximity measure that was used to define the groups. For example, each group of devices may be replaced by a single node that aggregates all communications between its member devices. For example, as shown in FIG. 10A, four groups 1000, 1002, 1004, and 1006 of four devices each may be replaced by four aggregate nodes 1000′, 1002′, 1004′, and 1006′ as shown in FIG. 10B. The communications between aggregate nodes 1000′ and 1002′ will, for example, be the aggregate of all communications between the devices of group 1000 and group 1002. Where the group proximity measure is the actual physical distance between the devices, the location of an aggregate node may be defined as the center of the group that it replaced, i.e., the center of the locations of the devices of the group. The distance between two groups may then be defined as the distance between their respective aggregate nodes. In this manner, “neighboring” groups may be identified by again employing a clustering algorithm or by defining neighboring groups as those groups that are within a predefined distance from each other. Alternatively, for each group a set of neighboring groups may be defined which may be the N closest groups to the group or all groups that are within a certain group proximity measure to the group. Since, as it is believed, malicious software is more likely to be transferred between neighboring groups than between distant groups, should suspect virus activity be detected in one group, neighboring groups may be notified and placed on alert as described hereinabove. If different groups use different malicious software sensing mechanisms, neighboring groups may be alerted to use the same sensing mechanisms as used by the first group in order to identify the malicious software activity. For example, if mail decoy activation is found in one group, neighboring groups may be informed to set up the same decoy. Alternatively, if a change to a certain software variable is used to identify the malicious software in one group, the same change may be monitored for in neighboring groups. Similarly, if e-mail messages are sent without the user's knowledge or direct intervention in one group on more occasions than indicated by a predefined threshold, this may also indicate that malicious software is present. In such a case, neighboring groups may be alerted to look for the same activity.

Target behavior as described hereinabove with reference to FIGS. 5 and 6 may also be correlated between neighboring groups to identify suspicious behavior.

Once the groups are defined, it is possible to define and measure different parameters that are indicative of the methods of operation within and between the groups. Over time the characteristic values of these parameters during normal operation may be learned. During an attack by malicious software these parameters form the basis for learning of the spread pattern of the malicious software in the network. Changes in one or more of these parameters may then be used as an indication of possible malicious software behavior within the network. For example, the number of messages sent within and between members of a group may be measured over a period of time. The ratio of these two numbers may be calculated and monitored. For example, the ratio of the number of e-mail messages sent within a group to the number of e-mail messages sent from members of the group to members outside the group in a given period of time may be calculated. If the ratio changes by more than a predefined amount as compared with a previous measurement or with the characteristic value (e.g., by more than 10%), this may also indicate that malicious software is present. This may be extended by looking not just at communications within a group and outside a group, but at communication between a group and its closest neighbors. For example, if 50% of the communications outside group 1000 goes to group 1002, a reduction to 10% in the last time period measured may be considered suspicious and may indicate malicious software activity. Virus alerts may then be made, and neighboring groups may increase their detection resources as described hereinabove. Once an alert has ended, such as when no viral or suspicious activity has been identified for a predefined period of time, the alert level may be maintained, lowered, or returned to the previous level.

Alternatively, once suspicious activity is identified a trained human operator may analyze the behavior of computing devices within the suspected group. Since a group generally includes a significantly smaller number of computing devices than does the entire network, this may enhance the operator's ability to perform effective manual analysis and intervention.

In addition, when malicious software has been identified in several computing devices within a group, it is possible to isolate the mechanism that has been spreading the malicious software. For example, where malicious software is spread by e-mail, the e-mail attachment that when activated causes the malicious software to spread may be identified. A characteristic code may be generated for the attachment that distinguishes it from other such attachments. This may be done using well known “checksum” algorithms. The checksum may then be sent to neighboring computers within the group and to computers within neighboring groups which may then use the checksum to identify suspicious malicious software upon arrival at these computers.

In general, any method or behavior criteria described hereinabove with respect to an individual computing device may be applied to a group as well. Groups may often be seen as part of a hierarchical tree, such as groups in a corporate organization. The grouping process and the malicious software detection algorithms described above may be repeated at various levels of the corporate tree, such as for teams, then for departments, and then for divisions. For example, the ratio of communications within and between groups may be calculated for teams, then for departments, and then for divisions in an organization to look for malicious software activity.

As was described hereinabove with reference to FIG. 7, different groups 800 may employ different virus detection and target behavior correlation criteria. Any of groups 800 may have different sets of sensors, such as one live set and one test set. “Different set of sensors” may actually be different types of sensors, different thresholds for similar sensors, or different algorithms to identify suspicious activity based on the gathered data. The live set is used for implementation of virus containment protocols as described hereinabove, while the test set monitors for malicious software and logs the results in order to test new sensor and correlation algorithms. Live and test set responses to system events, such as actual virus detections and false alarms, may be compared to identify algorithm effectiveness. This may be performed retrospectively once a series of system alerts have been identified as either real virus alerts or false alarms.

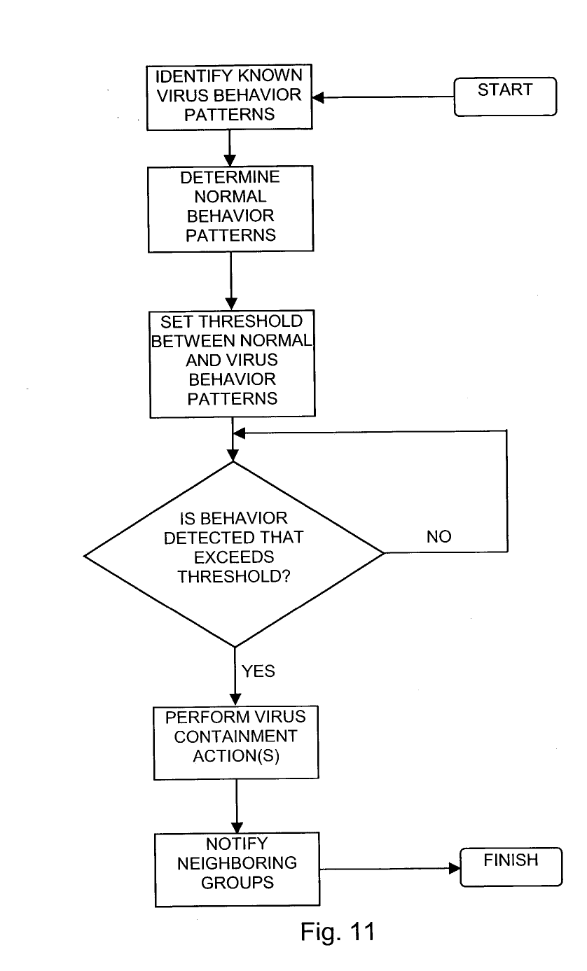

Reference is now made to FIG. 11, which is a simplified flowchart illustration of an exemplary method of operation of the system of FIG. 8, useful in understanding the present invention. In order to anticipate the propagation path of malicious software within and between groups 800, the behavior of previous malicious software may be studied. Virus behavior may be monitored in multiple ways, such as in terms of numbers of message per unit of time, shapes of utilization graphs, such as for disk storage access or CPU usage, graphs of e-mail messages per unit of time, histogram of communication frequency vs. proximity measure, the number of messages sent within the group, number of messages sent to the next closest group or to the third closest group, etc., histograms of e-mail lengths, histograms of the number of e-mail messages sent/received vs. the number of e-mail recipients per message, etc. For example, for each group a histogram may be constructed showing the distribution of e-mail message lengths. The histogram would show how many e-mail messages had a length of one word, two words, three words, etc. during a predefined historical time period. During normal operation the system may measure a standard distribution graph and monitor the extent of variation around that standard graph. A deviation that is significantly higher than the standard variation level may indicate the existence of malicious software activity, and one or more virus containment actions may be performed. For example, during normal operation a smooth e-mail length histogram would be expected. When malicious software is active, one or more ‘spikes’ in the distribution histogram could be present. Thus, a threshold may be defined of the maximum in the histogram as compared to the average. Alternatively, normal and current graphs may be overlaid, and the area between both the graphs calculated. An area that exceeds a predefined threshold may be deemed suspicious. In addition, where neighboring groups have been identified, neighboring groups may be notified as described hereinabove.

In order to gather virus propagation parameters, a virus may be introduced by the system administrator into one or more of groups 800. Such viruses would have the same propagation characteristics of standard malicious software but without any malicious “payload”. They would be used to cause “controlled” outbreaks that would allow for the measurement of characteristic parameters during virus outbreaks. This can also be used to learn the spread patterns of viruses within and between the groups.

It is appreciated that any of the correlation activity described hereinabove that is carried out by a server may be carried out by any computing device within a group. Peer-to-peer communication techniques may be used to transfer information within the group, and the correlation calculation may be performed by any of the computing device peers. A similar process may be implemented within neighboring groups to allow correlation of suspicious activities between groups.

The present invention may be employed to identify suspicious activity occurring in multiple groups simultaneously. For example, if suspicious behavior is detected at a computing device, and similar suspicious behavior is also detected in various groups to which the computing device belongs, virus containment actions may be taken in each of the groups. This may include, for example, where one computer sends out e-mail messages or makes voice calls that are not directly initiated by a human user, and similar activity is detected in multiple groups to which it belongs. Furthermore, this may be used as an indication that the specific computing device that is member of both groups is the source of the malicious software in each of the groups to which it belongs.

When malicious software originates at a single point within a network, it is generally expected that it will spread first within its group, then to the closest neighboring groups, then to the next closest neighboring groups, etc. Occasionally, the malicious software may “hop” over to a distant group as the result of a less frequent communication being made between an infected computing device and another device which is logically distant according to the relevant group proximity measure.

The present invention may be used to identify suspicious activity as it begins to spread within a first group and then receive a report of similar suspicious activity in a second group that is not a neighbor of the first group. In this case, the present invention may be used to analyze recent log files of communications between computing devices in the first and second groups. Since the groups are not neighbors, such communications are not likely to be found under normal circumstances. If a recent communication is identified between the two groups, this may be treated as a suspicious event. The communication may then be forwarded to a human operator for analysis to identify malicious software. In addition, this process may be used to identify the specific communication message that is carrying the virus, which may lead to containment actions being taken. For example, if several PCs in a first corporate work-team begin to send the same e-mail messages without human operator intervention, this may be identified as a suspicious event. Then the same event may be identified in a PC that belongs to a second work-team that does not communicate often with the first work-team. In this case, the e-mail log files may be searched for an e-mail message between a PC belonging to the first team and the PC in the second team exhibiting the suspicious behavior. If such an e-mail message is found, virus containment actions may be taken, with the e-mail message being forwarded to a system administrator as the message that is suspected of carrying the virus. The system administrator and/or an automatic system may then take steps to notify all network users of the suspicious e-mail message. Alternatively, the administrator and/or the automatic system may take steps to block this specific type of message from being sent or received within the network.

Alternatively, if identified suspicious behavior occurs within the same predefined time period in two or more non-neighboring groups, a search may be undertaken for an external source that brought the virus into the two groups at the same time. For example, the e-mail log files may be searched for a similar e-mail message that reached the groups in a previous predefined time period. If such an e-mail message is found it may be treated as described hereinabove.

The present invention may also be employed to identify simultaneous attacks by malicious software on a specific network resource that are intended to prevent the network resource from servicing legitimate requests for that resource. Such attacks are known as Denial of Service or Distributed Denial of Service attacks (DOS or DDOS). In one example of such an attack, multiple computers were maliciously configured to simultaneously attempt to access the Web site of the White House, thereby limiting or preventing legitimate access to it. In another example, multiple cellular telephone were commandeered by malicious software to simultaneously generate voice calls to an emergency number in Japan, thereby limiting or preventing access to that service. The present invention may thus be applied to group-level correlation to identify denial of service attacks by identifying, for example, voice calls that are not initiated through manual dialing but by software automatically dialing a number without direct human user intervention.

Those skilled in the art will thus appreciate that the present invention may be applied to individual computers or computing devices as well as to groups of such devices. Where group-level correlation is performed, group makeup may be reassessed periodically to adapt to typical changes in the group environment. For example, groups based on physical location may need to be reconstituted every 15 minutes while groups based on organizational membership, such as corporate e-mail groups, may be reassessed only once a month. For different sensors that are used to identify different types of propagation, different groups need to be used. For example, for sensors described above that relate to e-mail communication, groups defined by a group proximity measure that is relevant to e-mail communication may be used, whereas for sensors that detect malicious software that is communicated via local IR transmission, groups based on physical location proximity may be used.

It is appreciated that statistical analysis tools may be used to implement aspects of the present invention using conventional techniques to provide an improved ratio of virus detections to false alarms.

In the embodiments described hereinabove for detecting suspicious activities in a computer network different detectors (e.g. file deletion and Windows Registry access) and decoys (e.g. e-mail decoy) were defined. These will all be referred to from this point onward as sensors. Given a system of N computers, for each computer there are K active sensors that log any predefined suspicious event that takes place. That information is logged in a central database that logs for each event the type of event, time of event and on which computer it took place. As is described hereinabove, a malicious code alert may be generated when the number of events or some other parameter for those events fit a predefined pattern or reached predefined thresholds. In an alternative embodiment, the thresholds and patterns are not predefined. This answers a need in the market for a system that adapts itself to the normal behavior of each specific network and yet is easy to install and manage by system administrators.

The proposed system works in two phases to identify malicious code (from here on referred to as “viruses”). The two phases are: learning and detecting. In the learning phase all the sensors are fully operational in the same network that is to be protected by the virus detection system. Alternatively it is possible, but less preferable, to do the learning phases and detecting phases on different computer networks. In such a case some kind of normalization processes may be required in porting the data from one network to another. In the learning phase all events are logged in a learning database similar to the database described above. This is done for a substantial period of time, for example, one week. In addition, the system gets retrospective external inputs (from an operator or standard antivirus software) on when there was a virus in the system. Generally, commercial antivirus software can quite effectively identify an existence of a virus in the system after it has received the relevant updates from the antivirus vendor, usually within a few days of the initial virus outbreak. This input is logged in a virus outbreak database. The time period in which it is estimated that the virus was active and the computers that were affected are logged in the virus outbreak database. In some cases the existence of a virus is identified only a few days after the virus started its activity. For that reason, the learning database is analyzed and put into use only after a waiting period (for example, two weeks). It is assumed that there is a high probability that most of the viruses in the system will be identified within the waiting period.

The learning database is sorted according to the time of each event logged. The events are grouped into non-overlapping time slots of a predefined length (e.g. 5 minutes). The learning database is then filtered according to the data logged in the virus outbreak database. Any time slot that is logged in the virus outbreak database as having an active virus in the system is taken out of the learning database. Additionally, it may be advisable to similarly log and filter out any time slots that had an organized activity for many computers that may look like a virus (for example: a centrally managed software installation for many computers in the same time—this would create a massive access to Windows Registry that may look similar to a virus activity).

The remaining Z time slots are analyzed to provide an estimate for the probability distribution of the different events in the network. For each time slot, for each type of sensor, the number of events in that time slot are counted. So, if there are N computers in the network and Z time slots that were measured, for each detector there will be a series of Z whole numbers in the range 0-N inclusive representing the number of computers at each time slot that had suspicious activity detected by that specific sensor type for that specific time slot. The number of times each value 0-N appears in this series is counted. This number divided by Z is used as an estimate for the probability to get that value in this computer network. Based on that calculated probability distribution, an estimated probability may be calculated for each detector to have a number of events or higher in the network in a specific time slot (e.g. the probability of having within a 5 minute time slot 4 computers or more in the network of 1000 computers activate the sensor of accessing specific keys in the Windows Registry). Additionally it is possible to do a separate analysis for different times in the day (e.g. working hours vs. non-working hours).

In the detecting phase the system logs every event of a sensor identifying a suspicious behavior on a specific computer into a central database. The logging preferably includes the type of event, the time it occurred and on which computer it occurred (if relevant). Either every predefined period of time or upon each event, the system queries the database for all events that took place during the last time slot. For example, if the time slot is 5 minutes, it gets all the events that took place in the past 5 minutes. These events are grouped by the sensor type and counted for that sensor type. Thus, for example, it may be found that for the last 5 minute time slot 0 computers sent e-mails to a decoy address, 2 computers accessed a specific key in the Windows Registry and 5 computers accessed a decoy file. For each sensor, the probability of getting that result or a higher in a network without a virus is estimated based on the results in the learning database that were analyzed as described above. For example, if in the past 5 minutes there were 3 events of accessing the Windows Registry, the system checks what was the measured probability of having 3 or more computers with a Windows Registry event in the learning phase. It is then possible to estimate what is the combined probability that the different detectors would have the values that were measured assuming that there is no virus in the system. For example, all the results for the detectors for that time slot are converted to probabilities of having that value or higher as described above. The lowest 3 probabilities are taken, and a binomial distribution calculation is done for getting 3 successes out of K attempts when the probability of success is equal to the highest of the 3 probabilities. The result is an estimate of the probability to get the result that was measured assuming that there is no virus in the system. Then the result is compared to a predefined threshold. If the calculated value is lower than the predefined threshold, the system can activate a virus alarm and possibly initiate virus containment actions. The lower the threshold the less false alarms the system will have and the less sensitive it will be to identifying viruses. The system additionally can have an option to have the operator enter information on whether at that time slot there is a centralized operation that may look like a virus operation, e.g. a mass software installation in the network. In that case the sensors that may be activated by such an operation (e.g. Windows Registry sensors) may be disregarded for the time period defined by the operator for the centralized operation.

It is appreciated that one or more of the steps of any of the methods described herein may be omitted or carried out in a different order than that shown, without departing from the true spirit and scope of the invention.

While the methods and apparatus disclosed herein may or may not have been described with reference to specific hardware or software, it is appreciated that the methods and apparatus described herein may be readily implemented in hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A method substantially as described hereinabove.

2. A method substantially as illustrated in any of the drawings.

3. Apparatus substantially as described hereinabove.

4. Apparatus substantially as illustrated in any of the drawings.

5. A system substantially as described hereinabove.

6. A system substantially as illustrated in any of the drawings.
